(19) United States
(12) Patent Application Publication
(10) Pub. No.: US 2025/0175023 A1
(43) Pub. Date: May 29, 2025

(54) Accumulator with two interface devices

(71) Applicant: Hilti Aktiengesellschaft, Schaan (LI)

(72) Inventors: Philipp BRAUN, Kaufbeuren (DE); Mathias FRENZEL, Unterdießen (DE); Klaus HAUSER, Schwabmünchen (DE); Bernd ZIEGLER, Schabmünchen (DE); Andreas GUGGEMOS, Bad Wörishofen (DE)

(21) Appl. No.: 18/842,857

(22) PCT Filed: Feb. 22, 2023
(86) PCT No.: PCT/EP2023/054463

§ 371 Date: Aug. 30, 2024

(30) Foreign Application Priority Data
Mar. 1, 2022 (EP) 22159556.4

(51) Int. Cl. H02J 7/00; H01M 10/42; H01M 50/211; H01M 50/213; H01M 50/247; H01M 50/296

(52) U.S. Cl. CPC H02J 7/0063; H01M 10/425; H01M 50/211; H01M 50/213; H01M 50/247; H01M 50/296; H02J 7/00036; H02J 7/00712; H01M 2010/4278; H01M 2220/30

(57) ABSTRACT

An accumulator, in particular as a releasable energy source for a power tool, containing at least one energy storage cell. The accumulator contains at least a first and second interface device, wherein the at least first and second interface devices are configured both to charge the at least one energy storage cell with electrical energy and to discharge electrical energy from the at least one energy storage cell. System containing a power tool and at least one accumulator, which is able to be connected to the power tool.

The present invention relates to an accumulator, in particular as a releasable energy source for a power tool, containing at least one energy storage cell.

Furthermore, the present invention relates to a system containing a power tool and at least one accumulator, which is able to be connected to the power tool.

### BACKGROUND

Accumulators are largely known from the prior art and can be used, inter alia, to be connected to power tools in such a way that the power tool can be supplied with electrical energy from the accumulator. For this purpose, the accumulator essentially contains a multiplicity of energy storage cells (also called accumulator cells) positioned in a solid housing. By means of the energy storage cells, electrical energy can be stored by the accumulator and also provided for a load (e.g. a power tool).

On one side of the housing of the accumulator, provision is made here for an interface by way of which the accumulator can be releasably connected either to a power tool or to charging apparatus. In order to charge an accumulator with electrical energy, the accumulator is releasably connected to the charging apparatus. According to the prior art, the charging apparatuses have an interface on a top side of the housing of the charging apparatus, by way of which interface the accumulator is mechanically and electrically connected to the charging apparatus.

### SUMMARY OF THE INVENTION

Charging apparatuses, and in particular those which are used for charging the accumulators for power tools, have a relatively elaborate and complex configuration. The relatively elaborate and complex configuration of these charging apparatuses is due to the fact that the charging apparatuses are used, inter alia, in harsh or strenuous environments (e.g. on construction sites or in workshops) and at the same time sophisticated accumulators have to be supplied with electrical energy in-in some instances-complicated charging processes. For this purpose, these charging apparatuses, on the one hand, have to have a very solid and durable configuration and, on the other hand, have to be configured with sensitive technology.

The configuration of the interface on the charging apparatus constitutes a particular technical challenge here. This is because the interface is usually open at the top and the electrical connections are therefore also exposed to the risk of water and/or dust being able to penetrate through them into the interior of the charging apparatus. The penetrating water can lead, inter alia, to defects in the form of short circuits in the charging apparatus and consequently permanently damage the charging apparatus. Penetrating dust and other dirt can damage the charging apparatus as well.

It is an object of the present invention to solve the problem described above.

The present invention provides an accumulator, in particular as a releasable energy source for a power tool, containing at least one energy storage cell.

According to the invention, the accumulator contains at least a first and second interface device, wherein the at least first and second interface devices are configured both to charge the at least one energy storage cell with electrical energy and to discharge electrical energy from the at least one energy storage cell.

According to an alternative embodiment, it may be possible for the first and second interface devices to be configured to transmit and receive signals and/or data.

According to a further alternative embodiment, it may be possible for the at least first or second interface devices to be configured as a USB socket.

According to a further alternative embodiment, it may be possible for the at least first or second interface devices to be configured as a cable with at least one USB plug.

According to a further alternative embodiment, it may be possible for a current and voltage value detection device and/or a current and voltage value setting device to be contained.

According to a further alternative embodiment, it may be possible for a communication device to be contained. The communication device can be designed as an IoT module (Internet of Things module).

Furthermore, the present invention provides a system containing a power tool and at least one accumulator, which is able to be connected to the power tool.

According to the invention, the accumulator contains at least a first and second interface device, wherein the at least first and second interface device is configured both for charging the at least one energy storage cell with electrical energy and for discharging electrical energy from the at least one energy storage cell, and the power tool contains at least a third interface device, wherein the at least third interface device is configured for releasable connection to at least the first or second interface device and for receiving electrical energy.

According to a further alternative embodiment, it may be possible for the third interface device to be configured to transmit and receive signals and/or data.

According to a further alternative embodiment, it may be possible for the accumulator to contain a current and voltage value detection device and/or a current and voltage value setting device as part of the system. It should be noted here that in the system, only the accumulator contains a current and voltage value detection device and/or a current and voltage value setting device.

According to a further alternative embodiment, it may be possible for the at least first or second interface device of the accumulator to be configured for discharging the accumulator with a voltage value of 21 to 60 V, in particular 48 V.

According to an alternative embodiment, it may be possible for the at least first or second interface device of the accumulator to be configured for discharging the accumulator with a voltage value of 1 to 10 A, in particular 5 A.

According to a further alternative embodiment, it may be possible for the at least first or second interface device of the accumulator to be configured for discharging the accumulator with a power value of 21 to 600 W, in particular 240 W.

According to an alternative embodiment, it may be possible for the at least first or second interface device of the accumulator to be configured for discharging the accumulator with a voltage value of 6 to 42 V.

According to a further alternative embodiment, it may be possible for the at least first or second interface device of the accumulator to be configured for discharging the accumulator with a current value of at least 200 A.

According to a further alternative embodiment, it may be possible that the at least first or second interface device of the accumulator is configured to discharge the accumulator with a power value of 1200 to 8400 W.

### BRIEF DESCRIPTION OF THE DRAWINGS

Further advantages will become apparent from the following description of the figures. Various exemplary embodiments of the present invention are illustrated in the figures.

The figures, the description and the claims contain numerous features in combination. A person skilled in the art will expediently also consider the features individually and combine them to produce useful further combinations.

In the drawings:

FIG. 1 shows a schematic side view of a power tool according and an accumulator, connected to the power tool, according to a first embodiment;

FIG. 2 shows a schematic side view of the accumulator according to the first embodiment connected to a charging apparatus;

FIG. 3 shows a schematic side view of the accumulator according to the first embodiment connected to a smartphone;

FIG. 4 shows a schematic side view of an accumulator according to a second embodiment; and

FIG. 5 shows a schematic view of the accumulator according to the second embodiment.

### DETAILED DESCRIPTION

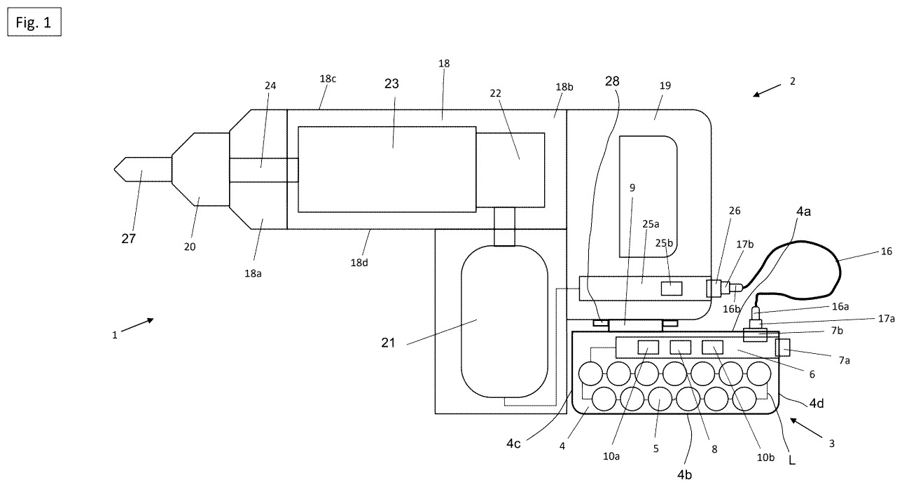

FIG. 1 shows a system 1 according to the invention made up of a power tool 2 and an accumulator 3 according to a first exemplary embodiment. The accumulator 3 is connected here releasably to the power tool.

The accumulator 3 serves as a releasable energy supply for the power tool 2. As described below, another device can be supplied with electrical energy by the accumulator 3 instead of the power tool 2.

The accumulator 3 contains fundamentally an accumulator housing 4, a multiplicity of energy storage cells 5, a control device 6, a first and second interface device 7a, 7b and a communication device 8.

The energy storage cells 5 serve to receive and store electrical energy. In the present exemplary embodiment, the energy storage cells 5 are embodied as cylindrical cells on the basis of lithium-ion technology. Alternatively, the energy storage cells 5 can also be embodied in the form of pouch cells.

As shown in FIG. 1, the individual energy storage cells 5 and the control device 6 are positioned inside the accumulator housing 4. The energy storage cells 5 are electrically connected to each other and to the control device 6 via lines L. The connection allows electrical energy to be conducted from or to the energy storage cells 5.

The accumulator housing 4 has a top side 4a, an underside 4b, a front side 4c, a rear side 4d, a left side wall and a right side wall. The left side wall and right side wall are not shown in the figures.

As shown in the figures, a connection device 9 is positioned on the top side 4a of the accumulator housing 4. The connection device 9 serves for releasably connecting the accumulator 3 to the power tool 2. In the present exemplary embodiment, the connection device 9 of the accumulator 3 is designed as a first component of a rail system.

In FIGS. 1 to 3, the accumulator 3 according to the first embodiment is shown, wherein the first interface device 7a is positioned at the rear side 4d and the second interface device 7b is positioned at the top side 4a. Alternatively, the interface devices 7a, 7b may be positioned at other locations or more than two interface devices 7a, 7b may be provided.

According to the first exemplary embodiment of the accumulator 3, both the first and second interface devices 7a, 7b are configured as a USB-C socket (i.e., USB type C socket). By configuring the first and second interface devices 7a, 7b as a USB-C socket, it is possible that, in addition to receiving and outputting electrical power via the interface devices 7a, 7b, electrical signals for exchanging data and information can also be transmitted and received via the interface devices 7a, 7b.

The control device 6 contains fundamentally a current and voltage value detection device 10a, a current and voltage value setting device 10b, and the communication device 8.

The current and voltage value detection device 10a is used for measuring and determining current and voltage values. The current and voltage value setting device 10 is used for setting a specific current value and voltage value. The communication device 8 is used for generating, transmitting, receiving, and processing electrical signals for exchanging data and information. The communication device 8 can be of a wired or wireless design. In the case of the wireless embodiment, it can be a Bluetooth communication device.

The control device 6 can be used to control the individual functions of the accumulator 3. The functions of the accumulator 3 include, among other things, controlling the input of electrical energy into the energy storage cells 5 and the output of electrical energy from the energy storage cells 5. The control device 6 is designed here in particular to control the voltage value, the current value or the power value for the input (i.e. when charging the energy storage cells 5) or for the output (i.e. when discharging the energy storage cells 5) of electrical energy into or from the energy storage cells 5.

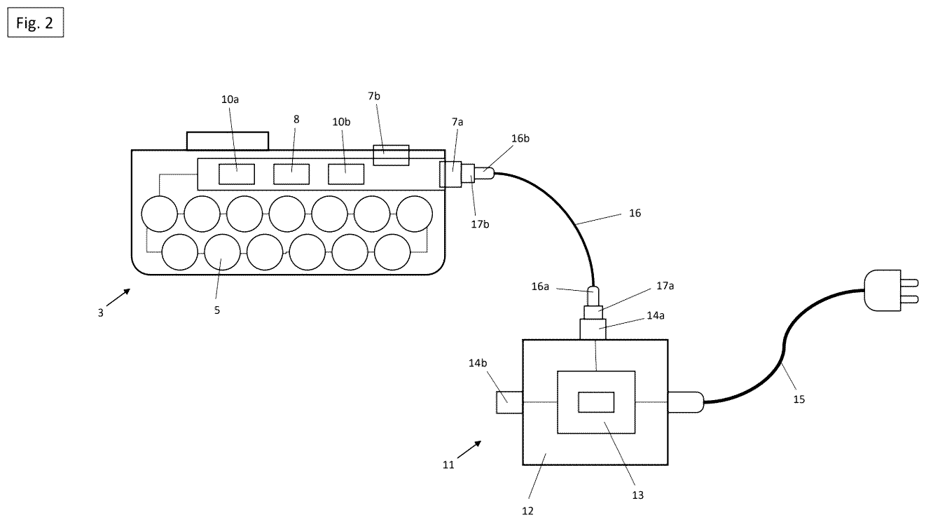

In FIG. 2, the accumulator 3 according to the first exemplary embodiment is shown releasably connected to a charging apparatus 11. The charging apparatus 11 is used to supply one or more accumulators 3 with electrical energy. In addition, the charging apparatus 11 is also configured to receive electrical energy from one or more connected accumulators 3. The electrical energy received from the accumulators 3 can be stored in an energy store 5 of the charging apparatus 11.

The charging apparatus 11 contains fundamentally a charger housing 12 with a control device 13, a first and second interface 14a, 14b and a power cable 15.

The control device 13 can be used to control the individual functions of the charging apparatus 11. The functions of the charging apparatus 11 include, among other things, controlling the output of electrical energy to the accumulator 3 or to the energy storage cells 5 of the accumulator 3. The control device 11 is designed here in particular to control the voltage value, the current value or the power value for the output (i.e. when charging the energy storage cells 5) of electrical energy to the energy storage cells 5 of the connected accumulator 3.

The first and second interfaces 14a, 14b are designed as USB-C sockets (i.e. USB type C sockets) so that corresponding USB-C plugs can be connected.

The power cable 15 can be used to releasably connect the charging apparatus 11 to a mains power source (i.e., wall socket) to receive electrical power.

As also indicated in FIG. 2, the charging apparatus 11 can be connected to the accumulator 3 via a connection cable 16. For this purpose, the connection cable 16 has a first plug connector 17a at a first end 16a and a second plug connector 17b at a second end 16b. In the present exemplary embodiment, both the first plug connector 17a and the second plug connector 17b are in the form of a USB-C plug connector (i.e., USB type C plug connector), so that the first plug connector 17a can be plugged into the first interface device, configured as a USB-C socket, of the accumulator 3 and the second plug connector 17b can be plugged into the first interface 14a, configured as a USB-C socket, of the charging apparatus 11.

The electrical energy received by the power cable 15 from the wall socket is conducted from the first interface 14 of the charging apparatus 11 via the connection cable 15 to the first interface device 7a of the accumulator 3 and finally to the energy storage cells 5 of the accumulator 3.

By designing the interface devices 7a, 7b on the accumulator 3 as well as the charging apparatus 11 in the form of a USB-C socket, a voltage value of 21 to 60 V, and in particular 48 V, a current value of 1 to 10 A, in particular 5 A, as well as a power value of 21 to 600 W, in particular 240 W, can be set for transferring electrical energy from the charging apparatus 11 to the accumulator 3.

According to the exemplary embodiment in FIG. 1, the power tool 2 is designed in the form of a hammer drill. Alternatively, the power tool 2 can also be designed in the form of a power drill, a saw, a grinder or the like.

As also shown in FIG. 1, the power tool 2 fundamentally contains a housing 18, a handle 19, a tool fitting 20 for a tool 27, a drive 21, a gear device 22, an impact device 23, an output shaft 24, a control device 25, and a third interface device 26.

The housing 18 here contains fundamentally a front end 18a, a rear end 18b, an upper end 18c and a lower end 18d.

The handle 19 is used to hold and guide the power tool 2 and is positioned at the rear end 18b of the housing 18.

The tool fitting 2 serves to receive and hold a tool 27, embodied as a drill, and is positioned at the front end 18a of the housing 18.

The drive 21 is embodied in the form of a brushless electric motor and serves for generating a torque.

As also shown in FIG. 1, the drive 21 is designed as an electric motor, the gear device 22, the impact device 23, the output shaft 24 and the tool fitting 20 are arranged relative to one another in the housing 18 of the power tool 2 in such a way that the torque generated in the drive 21 is transmitted to the tool fitting 20 via the gear device 22, the impact device 23, and the output shaft 24.

The control unit 25a is used to control the individual functions of the power tool 2. Furthermore, the control device 25a contains a communication unit 25b for transmitting and receiving data or information in the form of electrical signals. By means of the communication unit 25b, a communication and a related exchange of data and information can be generated between the power tool 2 and the communication device 8 of the accumulator 3. The communication unit 25b of the power tool 2 can be of a wired or wireless design.

As shown in FIG. 1, an attachment device 28 is positioned below the handle 19. The attachment device 28 serves for releasably connecting the power tool 2 to the accumulator 3. The attachment device 28 of the power tool 2 is designed as a second component of the rail system, so that the attachment device 28 can be releasably connected to the corresponding connection device 9 of the accumulator 3. In FIG. 1, the connection device 9 of the accumulator 3 is connected to the attachment device 28 of the power tool 2.

The third interface device 26 is also designed as a USB-C socket (i.e. USB type C socket). Through the third interface device 26, electrical energy can be supplied via the control device 11 to the consumers of the power tool 2, for example to the drive 21. To supply electrical energy to the power tool 2, the third interface device 26 of the power tool 2 is connected to the accumulator 3. For this purpose, the first end 16a of the connection cable 16, designed as a USB-C plug, is connected to the third interface device 26, designed as a USB-C socket, and the second end 16b of the connection cable 16, designed as a USB-C plug, is connected to the second interface device 7b, designed as a USB-C socket, of the accumulator 3. Through the connected connection cable 16, both electric power and electric signals can be transferred for data and information exchange between the power tool 2 and the accumulator 3.

After connecting the accumulator 3 to the power tool 2, communication is first established in the form of an exchange of corresponding signals between the accumulator 3 and the power tool 2. By establishing communication, the specific charging characteristics or charging parameters for the energy storage cell 5 of the power tool 2 can be transmitted to the accumulator 3, so that the charging characteristics or charging parameters are set with the aid of the control device 6. The charging characteristics or charging parameters are the specific charging voltage, charging current or charging power suitable for the energy storage cell of the smartphone. By designing the interface devices on the accumulator as well as the power tool 2 in the form of a USB-C socket, a voltage value of 21 to 60 V, and in particular 48 V, a current value of 1 to 10 A, in particular 5 A, as well as a power value of 21 to 600 W, in particular 240 W, can be set for transferring electrical energy from the accumulator to the power tool.

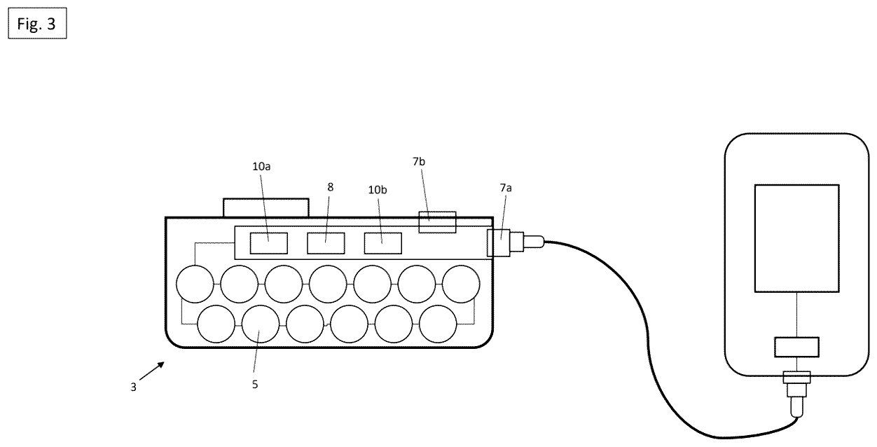

In FIG. 3, the accumulator 3 according to the first exemplary embodiment is shown releasably connected to a smartphone 29. The smartphone 29 contains fundamentally a control device 30, an energy storage cell 31, and a USB-C socket as a connector 32 for transmitting electrical energy. The USB-C socket 32 may also be used to transmit and receive electrical signals for communication. For connecting the accumulator 3 to the smartphone 29, the connection cable 16 with the first USB-C plug connector 17a is connected to an interface device 7a, 7b of the accumulator 3 configured as a USB-C socket, and with the second USB-C plug connector 17b is connected to the as a USB-C socket 32 of the smartphone 29. By connecting the accumulator 3 to the smartphone 29, communication is first established in the form of an exchange of corresponding signals between the accumulator 3 and the smartphone 29. By establishing communication, the specific charging characteristics or charging parameters for the energy storage cell 31 of the smartphone 29 can be transmitted to the accumulator 3, so that the charging characteristics or charging parameters are set with the aid of the control device 6 of the accumulator 3. The charging characteristics or charging parameters are the specific charging voltage, charging current or charging power suitable for the energy storage cell 31 of the smartphone 29.

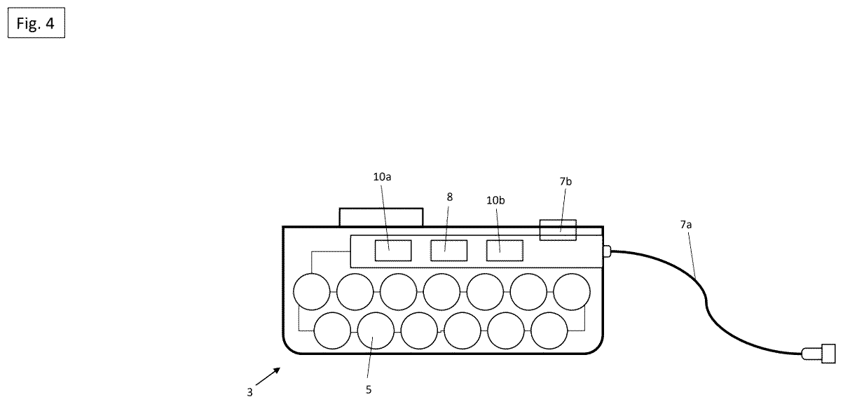

FIG. 4 shows the accumulator 3 in accordance with a second exemplary embodiment. The accumulator 3 according to the second exemplary embodiment is substantially identical to the accumulator 3 according to the first exemplary embodiment. In contrast to the first exemplary embodiment, the accumulator 3 according to the second exemplary embodiment contains a first interface device 7a in the form of a cable 33 having a USB-C plug connector and a second interface device 7b in the form of a USB-C socket.

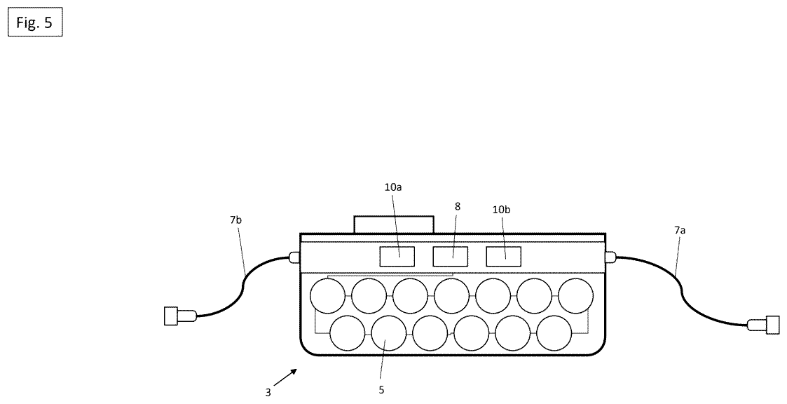

FIG. 5 shows the accumulator 3 in accordance with a third exemplary embodiment. The accumulator 3 according to the second exemplary embodiment is substantially identical to the accumulator 3 according to the first exemplary embodiment. In contrast to the first exemplary embodiment, the accumulator 3 according to the third exemplary embodiment includes a first interface device 7a in the form of a first cable 33 having a USB-C connector and a second interface device 7b in the form of a second cable 34 having a USB-C connector.

### LIST OF REFERENCE SIGNS

1 System
2 Power tool
3 Accumulator
4 Accumulator housing
5 Energy storage cell
6 Control device of the accumulator
7a First interface device of the accumulator
7b Second interface device of the accumulator
8 Communication device
9 Connection device
10a Voltage value detection device
10b Current and voltage value setting device
11 Charging apparatus
12 Charger housing
13 Control device of the charger housing
14a First interface
14b Second interface
15 Power cable
16 Connection cable
16a First end of the connection cable
16b Second end of the connection cable
17a First plug connector of the connection cable
17b Second plug connector of the connection cable
18 Housing of the power tool
18a Front end of the housing of the power tool
18b Rear end of the housing of the power tool
18c Upper end of the housing of the power tool
18d Lower end of the housing of the power tool
19 Handle
20 Tool fitting
21 Drive
22 Gear device
23 Impact device
24 Output shaft
25a Control device
25b Communication unit
26 Third interface device
27 Tool
28 Attachment device
29 Smartphone
30 Control device of the smartphone
31 Energy storage cell of the smartphone
32 Connection of the smartphone
33 First cable
34 Second cable
L Leads

What is claimed is:

1-8. (canceled)

9. An accumulator for use as a releasable energy source for a power tool, the accumulator comprising:
at least one energy storage cell;
at least a first and second interface, wherein the at least first and second interfaces are configured both to charge the at least one energy storage cell with electrical energy and to discharge electrical energy from the at least one energy storage cell.

10. The accumulator as recited in claim 9 wherein the first and second interfaces are configured to transmit and receive signals or data.

11. The accumulator as recited in claim 9 wherein the first or second interface devices are configured as USB sockets.

12. The accumulator as recited in claim 9 wherein the first or second interface device is as a cable with at least one USB plug connector.

13. The accumulator as recited in claim 9 further comprising a current and voltage value detector or a current and voltage value setting device.

14. The accumulator as recited in claim 9 further comprising a communication device.

15. A system comprising:
a power tool; and
at least one accumulator connectable to the power tool, the accumulator including at least a first and second interface, wherein the first and second interfaces are configured both for charging at least one energy storage cell with electrical energy and for discharging electrical energy from the at least one energy storage cell, and the power tool includes at least a third interface device, wherein the third interface device is configured for releasable connection to at least the first or second interface device and for receiving electrical energy.

16. The system as recited in claim 16 wherein the third interface device is configured to transmit and receive signals or data.
